(19) United States
(12) Patent Application Publication
(10) Pub. No.: US 2016/0002941 A1
(43) Pub. Date: Jan. 7, 2016

(54) HIGH EFFICIENCY, LOW-PRESSURE FILTRATION UNIT

(71) Applicant: John Thomas Riedl, Northbridge, New South Wales (AU)

(72) Inventor: John Thomas Riedl, Northbridge, New South Wales (AU)

(21) Appl. No.: 14/770,397

(22) PCT Filed: Feb. 25, 2014
(86) PCT No.: PCT/IB2014/059223

§ 371 Date: Aug. 25, 2015

(30) Foreign Application Priority Data
Feb. 25, 2013 (AU) 20139000641

(51) Int. Cl. E04H 4/12; B01D 24/00; B01D 24/46

(52) U.S. Cl. CPC E04H 4/1209; B01D 24/4631; B01D 24/002

(57) ABSTRACT

A swimming pool water filtration unit includes: a plurality of shallow-bed sand filter modules that receive water from a swimming pool and discharge filtered water simultaneously via a pool water return conduit common to all modules. A valve arrangement associated with the filter modules: (i) selectively but simultaneously switching on and off of all filtered water flow from the trays, which takes place through the return conduit common to all trays, to the pool water return coupling of the tank; and (ii) enable backwash water flow into the individual filter trays in selectable order, preferably through the common return conduit, and opens a conduit for backwash water to pass to waste in a switching state where water flow to the pool water return coupling is blocked.

### RELATED APPLICATIONS

The present application is a National Phase entry of PCT Application No. PCT/IB2014/059223, filed Feb. 25, 2014, which claims priority from AU Patent Application No. 20139000641, filed Feb. 25, 2013, all said applications being hereby incorporated herein by reference in their entireties.

### FIELD OF THE INVENTION

The present invention concerns filters for swimming pools, but may be used for other applications.

### BACKGROUND TO THE INVENTION

There are various types of filtration devices used for filtering swimming pool water. Commonly employed swimming pool filtration systems use pressurized rapid sand filters connected in line with a pump and with pool water inlet and outlet pipes to provide a water recirculation circuit to/from the pool through the filter.

Rapid sand filters use granulated, mineral media as a filter medium, contained in a pressure vessel or tank. The filter medium is typically a fine silica sand of a specified grade or sometimes Zeolite, specialty glass beads or other granulated filter materials. In this specification, the term ‘sand’ will be used generically to denote all of these alternative granulate filter materials.

Typical domestic pool rapid sand filters use pressure vessels or tanks to contain the filter medium. These tanks are typically spherical or cylindrical with hemispherical ends in shape, having a base footprint diameter of between 450 to 1000 mm and a height of 800 to 1300 mm. The tanks are charged with an amount of filter medium (e.g. sand) to a depth typically in the order of 270 mm to 400 mm to provide an exposed filter medium surface area of typically 0.25 to 0.8 m².

Also, typical domestic rapid sand pool filtration systems use single speed pumps which are sized (rated) to meet filter medium backwash requirements, with pressure and flow ratings that are significantly greater than those needed for normal filtration operation (i.e. when in forward flow filtration mode), typically three times as great.

Conventional rapid sand filters with single speed pumps therefore typically operate at much higher flows and consequently pressures than if the pump were selected for forward flow requirements only. In addition, they need deeper filter beds (and thus larger sand loads) to reduce the effects of high-pressure water flows fragmenting suspended material in the water and blowing smaller resulting particles in the inlet water right through the filter and back into the pool.

During backwashing, which is conducted typically at high pressures and water flow rates sufficient to fluidize the sand filter bed, water flows backwards from the pool into the bottom of the tank and through the filter into a waste line, taking with it dirt previously accumulated in the filter bed. This is a considerable waste of (pool) water, and also the chemicals it contains. Often, up to a quarter of the water in a residential swimming pool is wasted each year in backwashing. In commercial pools, backwashing may empty multiple pool contents over the course of a year, wasting not only the ‘cleanliness’ of the water but also the chemicals and energy it contains in the case of heated water.

Another drawback of existing rapid sand filtration systems is the need to use equipment components which are typically rated, for safety reasons, at multiples of rated filtration pressures, whereby normal operation is mostly between 12 to 40 psi (82.7 to 275.8 kPa or 0.827 to 2.76 bar), typically up to 250 psi or more. This in turn means that such systems are relatively expensive.

Generally speaking, sand filtering should ideally be as fast as required to meet the water turn-over requirements for cleanliness, while also otherwise operating as slow as practical to reduce pressure losses in the plumbing and filtration system, such losses in general being approximately proportional to the square of the rate of flow. With lower pressures also, smaller particles can more easily be retained in the filter media and particulate matter is less prone to shredding.

Ideally, then, devising a swimming pool filter which enables low-pressure, low-flow filtration with a single speed pump of small size and cost would be desirable, also because such filters will clean more finely than high-pressure filtration, all else being equal.

### SUMMARY OF THE INVENTION

Broadly speaking, embodiments of the invention foresee a pool water filtration unit, having a filter tank dimensioned to receive a charge of filter sand for effecting filtration of pool water in continuous, pump assisted flow through the tank, comprising multiple, shallow-bed sand filter modules located within or preferably forming part of an external wall of the tank, wherein the modules are arranged to receive in parallel (as compared to sequentially), in filtration flow mode, water from a pool at low delivery pressure and to discharge at low pressure filtered water from the modules through a pool water return conduit located within the tank and common to all modules. Preferably, sand, Zeolite, or combinations of these and/or other granulate filtering materials are used in the filter unit's modules.

In essence, instead of having a single deep-bed filter sand charge reside inside the tank, as per the above described prior art units and which is under relatively high pressure during operation of the unit, the total filtration sand charge is divided among the shallow-bed filter modules that make up the bulk of the tank, e.g. 3, 4 or 5 modules. This in turn means that one can use the same amount of sand as in a conventional rapid sand filter, in a tank of similar overall dimensions but distributed among the individual modules, thereby increasing the total top (or free) surface area of filter sand exposed to water inflow approximately n-fold, where n is the number of modules and assuming that the top surface area of the filter bed of each module is approximately the same as that of the conventional rapid sand filter tank. This increases filtration efficacy. Alternatively the total filter sand charge could be reduced without compromising filtration efficiency, noting that filtration of particulate matter from swimming pool water typically takes place predominantly in a relatively thin layer below the top (free) surface area the sand filter bed, the increased total surface area provided by the multiple modules leading to increased filtration efficacy.

Advantageously, the modules can be dimensioned to provide approximately the same foot-print area and together an overall similar filter tank volume as that of a conventional filter unit. The increase in effective filter surface area (provided at the multiple modules) and reduced filter media depth in each module enables significant reduction of the operating pressure of the filter unit during operation in effecting filtration, with pressure being inversely approximately proportional to the square of the filter surface area and also correlated with the depth of filter media.

Another benefit that flows from subdividing the sand filter charge is that individual modules may be backwashed selectively one at a time, thus obviating the need for a pump rated to provide large water flows in order to efficiently back-wash all the filter media and modules simultaneously. Thus, a smaller capacity pump (or other lower pressure backwashing water source) may be employed for performing backwashing of the filter unit. Also, the structural/mechanical demands on the filter unit modules can thus be reduced, making manufacture simpler and less expensive.

In backwash flow mode of the unit according to embodiments of the invention, water is directed selectively, using a suitable arrangement of valves, to the individual shallow bed modules whose filtration sand charge is inversely proportional to the total number of modules, and therefore a fraction of the combined amount in all modules, which in turn means that lower water flow rates and pressure will suffice to effect cleaning of each module.

Advantageously, the shallow bed filter modules comprise identical filter trays stacked in a column, which together with bottom and header caps define an enclosed low pressure vessel or tank. The tank will have a pool water inlet coupling and a pool water return coupling to which pool water supply and return lines can be connected, respectively. A waste water coupling is also provided, as per conventional units. The volume and foot print of the vessel so formed can be advantageously chosen to be comparable to those of typical rapid sand filters used to date, but because of the stacked filter trays, has an increased number of exposed filter material top surfaces and thus provides increased filtering capacity.

Advantageously, the filter unit incorporates valves associated with the filter modules/trays arranged for performing the following functions: (i) selectively and simultaneously switching on and off all filtered water flow from the trays, which takes place through the return conduit common to all trays, to the pool water return coupling of the tank; and (ii) enabling backwash water flow into the individual filter trays in selectable order, preferably through the common return conduit, and opening a path for backwash water to pass to waste in a switching state where water flow to the pool water return coupling is switched off.

Preferably, the pool water inlet coupling is provided at the bottom lid (although it could be at the header lid), and has a non-return valve, preferably in form of a flap (passive) valve. This measure eliminates the need to actively close-off the inlet water coupling during backwashing, pressure of backwashing within the filter tank holding the flap valve shut and preventing backwash water returning to the pool via the inlet. Alternatively, a solenoid or similar remotely or locally operable valve may be provided, arranged for manual shutting off the inlet. Such forced shut-off is advantageous in situations where the filter unit is located sufficiently far below the surface of the pool to provide a substantial head of water at the inlet coupling, tending to keep a flap-type valve in an open state against pressure in the tank during backwashing operations.

In a particularly preferred embodiment, the shallow bed filter trays are advantageously segmented to define discrete sub-volumes (or cells) in which respective loads of granulate filtering material are received. The valve assembly or mechanism will then be further modified/arranged to enable selective backwashing of the filter material loads in each segment (cell) of each tray, in a sequential manner. Such further subdivision of the entire filter media charge of the filter unit into the discrete holding cells at each tray greatly facilitates backwashing operations at low water pressure and flow values as compared to those employed in traditional rapid sand filters.

In a further preferred embodiment, the valve mechanism can be arranged to receive water from a mains water supply through a dedicated coupling at the filter unit, and selectively direct this flow to the individual filter trays (or the segments, where applicable) in order to effect backwashing of the filter medium received in the selected trays (or cells thereof). The pool water supply into the stacked trays will be switched off by the valve mechanism when backwashing takes place as previously described. Backwashing can thus be performed at low pressure using water with limited flow capacity as is typically available from a mains water supply (typical mains water pressure is between 30 and 60 psi although lower and higher values apply in some regions). This contrasts with high power pumps providing large flow volumes at relatively high pressures using pool water as is effected in typical rapid sand filter systems currently employed.

Alternatively, though not a preferred embodiment, the valve mechanism can be devised such that pool water itself may be used to perform backwashing by directing water flow to each segment in a tray in sequence.

In both embodiments, however, the valve mechanism will be further arranged to direct the backwash water to a waste water coupling of the filter unit, for discharge into canalization or re-use (recycling) facilities. A further alternative is to use a combined water stream from different sources such as mains water and pool water, or mains water supplemented by rain tank water, where water amount for backwashing is insufficient or undesirable from a single source alone.

Preferably, the filter unit comprises concentrically stacked, squat cylindrical filter trays, each comprising an outer peripheral wall with upper and lower circular edges advantageously configured to allow preferential form-locking stacking of trays on top of one another into the columnar arrangement, either self-sealingly or with an intermediate sealing ring or gasket. Suitable, additional constructional elements can be provided for securing/locking the stacked trays to one another, so as to maintain the filter unit's (i.e. tank's) watertightness under the operating pressure levels at which the filter unit will be operating. The trays can be secured permanently to one another either by gluing, solvent welding or using other permanent joining techniques, or can be secured in releasable manner to one another, using known (ring) clamping techniques.

The operating pressures will be typically an order of magnitude lower than traditional rapid sand filters using single speed pumps. The filter unit can be combined with pool pumps typically rated at between 1/10 and ¼ that of pool pumps used with existing rapid sand filter units while still achieving the same daily filtration outcome. Advantageously, the low operating pressure but relatively high flow rate enabled by the increase in filter areas exposed to pool water inflow enables the use of pumps with higher hydraulic efficiencies than conventional pool pumps. Consequent upon this set of operating conditions, more efficient impellers may be employed too. Pumps optimized to operate at approximately 10 psi maximum, as is envisioned in practical implementation of the invention, have superior flow rates at low pressure, often 2 to 3 times as much as higher pressure pumps of the same power, providing significant efficiency gains.

Advantageously, the cylindrical filter trays are designed to have an intermediate, cylindrical separation wall radially spaced from and concentrically located within the outer cylindrical peripheral wall, thereby defining an annular void between these cylindrical walls which, when the trays are stacked in sealing engagement, together provide a continuous annular flow channel which is in communication with the pool water inlet coupling of the unit. It is from this annular flow channel that that pool water can flow radially past the cylindrical separation wall into the filter tray segments/cells, which hold the filtering medium, located radially inwards the separation wall. To this end, the intermediate cylindrical wall will preferably have upper rim portions that are below the upper rim of the external peripheral wall, or cut outs or through holes, to enable radially inward and outward water flow past the separation wall.

The squat cylindrical filter trays are advantageously of double floor construction, preferably themselves modularly assembled, with an upper perforated floor located a distance below the rim of the intermediate cylindrical wall close to a bottom end of the tray, extending radially inward the intermediate cylindrical wall, and a lower solid floor spaced below and from the upper perforated floor, extending also radially inward the intermediate cylindrical wall. The lower solid floor provides a water passage impervious bottom zone of the tray.

The plurality of perforations in the intermediate floor are dimensioned and positioned to permit passage of water in a controlled flow and distribution pattern between the segmented upper part of the tray (which holds the filter medium) and the equally segmented volume defined between the upper perforated and lower floors, the segmentation being provided by radially extending webs.

Advantageously, if the perforations in the intermediate floor are chosen to be a size that would otherwise allow filter media to penetrate and possibly block said perforations, media can be kept out of the perforations by placing a suitable mesh of suitable size and open area over the perforations and held-in place to avoid it lifting during backwash.

Advantageously, a central tubular duct section is provided at each tray radially inwards and concentric with the intermediate wall. The duct sections provide, when the trays are stacked, the common return flow conduit of the filter unit for filtered water towards the pool water return coupling. To enable filtered water to pass from the trays into the return flow conduit, each duct section is provided with a number of tray water flow slots or holes equivalent in number to the number of segments of the tray, located in the region or space between the perforated upper and solid bottom floors only, thereby together providing the tray's filtered water discharge outlet. That is, water flow can take place from the annular flow channel past the intermediate cylindrical wall through the perforated upper floor and the tray water flow holes into the tubular innermost duct section, and vice versa.

In a preferred form, the switching valve arrangement or mechanism will comprise a first rotary sleeve valve, wherein a hollow tubular valve body (sleeve) is received form-fittingly and in rotatable manner within the common return flow conduit defined by the duct sections of the stacked trays, the valve body having a plurality of forward flow slots or holes in its peripheral wall, equally indexed in peripheral direction of the valve sleeve and spaced along the axial extension of the valve body in such manner as to selectively permit and shut-off water flow between the interior of the sleeve body and all cells in each tray, in parallel flow through the tray water flow holes, upon selective rotation of the sleeve.

Accordingly, when water flow is enabled, the inside of the valve body (ie the sleeve) will define the common return flow conduit of the filter unit for filtered water towards the pool water return coupling. The total minimum number of forward flow holes can be determined to be n×c, wherein n is the number of filtration trays comprised in the unit and c is the number of cells (or segments) present at each filter tray, and wherein the number of forward flow holes servicing each filter tray is the same as the number of tray water flow holes, the peripheral spacing between centers of the holes in the respective set of tray water flow holes and forward flow holes being the same.

For example, in the case of a filter unit with four trays and each filter tray having five segments (cells), the total number of forward flow holes in the sleeve will be 20, 5 associated with each tray (and thus each tray having five tray water flow holes), wherein the angular spacing of centers of the forward flow holes and the tray water flow holes will then be 72°.

The first rotary sleeve valve will furthermore advantageously have a number of backwashing water flow slots or holes in the peripheral wall of the rotatable sleeve, equal in number to the number of filtration trays of the unit, single ones of the backwashing flow holes arranged to service a respective one associated tray and located between two forward flow holes servicing the same tray. The backwashing flow holes are rotationally offset (or indexed) along the axial extension of the sleeve such that from all rotational positions in which water flow through the forward flow holes is maintained shut-off, selective rotation of the sleeve will cause the backwashing flow holes to align with the tray water flow holes in a predetermined sequence.

The valve arrangement or mechanism may advantageously further comprise a second rotary sleeve valve for selectively permitting and shutting-off water flow between the inside of the sleeve of the first rotary sleeve valve and the pool water return coupling of the filter unit.

More advantageously, the first and second rotary sleeve valves can share the same rotatable hollow tubular valve body (or sleeve), thus reducing part count of the valve mechanism. A plurality of water supply slots or holes form part of the second rotary sleeve valve and are formed in the sleeve at least in equal number to the number of segments (cells) of the filter trays in the unit. The water supply holes are indexed in a regular pattern in peripheral direction of the valve sleeve but rotationally off-set to the forward flow holes of the first rotary sleeve valve, and are arranged to selectively allow and shut-off passage of water between the interior of the sleeve and (i) a pool water return duct preferably provided at the header cap of the filter unit in communication with the pool water return coupling, and (ii) a backwash water supply duct equally preferably provided at the header cap of the filter unit in communication with the mains water supply coupling upon selective and sequenced rotation of the sleeve.

The sleeve can advantageously be supported in a cylindrical bush with discharge ports formed integral with or mounted to the header cap of the filter unit, the discharge ports opening into the pool water return duct.

Equally, the sleeve can be supported in another cylindrical bush formed integral with or mounted to the bottom (or footing) cap of the filter unit.

The valve arrangement or mechanism may advantageously further comprise a third rotary sleeve valve for selectively permitting and shutting-off water flow between the inside of the filter unit, which is in permanent communication with and includes the continuous annular flow channel defined by the stacked filter trays, and a waste (e.g. backwash) water duct which is sealed off from the remainder of the interior volume of the filter unit and which leads to a waste water discharge coupling of the filter unit.

Preferably, the third rotary sleeve valve comprises a cylindrical cup element having a number of discharge slots or holes formed in the peripheral wall thereof, in number equal to the number of cells of the filter trays and indexed with the same angular spacing as that of the tray water flow holes. The cylindrical cup can be made integral with or mounted with its closed upper end to the lower open end of the rotatable hollow tubular valve body (sleeve) of the first rotary sleeve valve for synchronous rotation therewith.

Alternatively, the cup element may be a simple tubular ring element, in which case the sleeve of the first rotary sleeve valve will be closed off at the interface with the first rotary sleeve valve. The point being that a fluid impervious barrier is defined between the common return flow conduit provided inside of the first rotary sleeve and the inside of the cup or ring element.

In a preferred arrangement, the cup (or ring) element is dimensioned to be fully received in form-fitting manner within the cylindrical bush formed integral with or mounted to the bottom (footing) cap of the filter unit, wherein the cylindrical bush will then have at least one egress port through which water may flow between the waste water duct defined within the bottom cap of the filter unit past one of the discharge holes into the inside of the cup (or ring) element, when rotationally aligned. An ingress port in the cylindrical bush, which is angularly separated from the egress slot, provides another water flow passageway between the inside of the cup (or ring) element and the inside of the bottom cap, and thus the annular flow channel defined within the filter unit by the stacked filter trays.

Angular indexing of (i) the egress and ingress ports at the bottom cap, (ii) the discharge holes of the third rotary sleeve valve, (iii) the backwash flow holes and the forward flow holes of the first rotary sleeve valve, (iv) the water discharge holes of the second rotary sleeve, and (v) the discharge ports at the header (top) cap may be determined and chosen such as to meet the following functional requirements: The number of backwash flow rotational states of the first and second rotary sleeve valves will be in number equal to the number of filter trays times the number of sectors (cells) in the trays. In each of the backwash flow rotational states, all of the forward flow holes are required to be blocked-off against the inside of the tubular duct sections of the filter trays. In these states, mains water (or other water used for backwashing) may enter into the common return flow conduit provided inside of the sleeve through the discharge ports in the header cap and the water discharge holes aligned therewith. Backwashing water can flow out from the sleeve past a sole one of the backwash flow holes that aligns (in the specific one of the different backwash flow positions) with a sole one of the tray water flow holes of the filter trays in the column, thereby delivering a backwash water flow past the perforated upper floor of the filter trays into a single one of all of the cells (segments) of the stacked filter trays. This causes a gentle but thorough backwashing by turning-over of the filter sand contained in the sole cell that is being backwashed, by virtue of water flow through the perforations in the upper floor. The backwashing water (with dirt particles removed from that cell) is forced essentially under water pressure derived from mains water pressure (which in turn may be suitably set or regulated by a separate pressure regulating valve) to flow past the rim of the intermediate cylindrical wall of the filter tray into the annular channel defined between the outer and intermediate cylindrical walls of the stacked trays, and from there towards the bottom cap's ingress port and through the discharge holes into the inside of the cup (or ring) element from where the flow continues past another discharge hole aligning (registering) with the egress port, into the refuse (e.g. backwash) water duct defined within the bottom cap.

The specific size and shape of the different ports and holes will be chosen to minimize flow restrictions that may lead to unacceptable pressure losses. Bernoulli's law of flowing water within a flow circuit can be used as a simplified model to determine suitable dimensions.

The filter unit can preferably be provided with a step motor mounted to the cap member, and which will effect selective rotation of the rotational sleeve (valve body) directly or through an appropriate gear arrangement.

Having a single valve sleeve selectively porting with the different water flow holes at the top and bottom caps, as well as the tray water flow holes, provides a very elegant constructional solution for the valve mechanism, minimizing part count and thus manufacturing/filter acquisition costs.

The filter trays will preferably be cast or otherwise manufactured from industrial grade, preferably but not necessarily reinforced polymers used in low pressure vessel manufacture, such as ABS, PVC and similar plastics with appropriate additives as may be required, such as to impart UV light protection.

Advantageously also, each segment (cell) of the filter trays will be provided with a polymer (or other material) mesh/sieve insert, with a sieve size sufficient to prevent filter material (e.g. sand particles) from clogging the perforations in the upper floor of the trays. Preferably, a plurality of small dimples may be present on an upper face of the perforated upper floor, to create discrete voids between the upper face proper of the upper floor and the sieve insert, facilitating backwash operations and ensuring appropriate fluidisation of the sand charge received in the cells.

It will thus be appreciated that the preferred valve assembly enables all segments (cells) in all filter trays to be switched to be in parallel for forward filtering and to be individually selected for reverse water flow for backwashing. Forward filtration operates so that all segments of all filter trays are open to forward flow from the filter tank through the filter media, through the supporting mesh, through the perforations, through the underlying cavities and through the forward flow holes of the valve assembly for return to pool. Backwash operates so that water is driven backwards through the valve arrangement sequentially into one segment of one tray at one time for sufficient time to backwash said segment effectively. This selection of segments is done by progressive stepwise rotation of the sleeve body of the valve assembly. The valve assembly in the lid cap allows filtered water to flow through the inside of the sleeve body to the water return line during normal filtering, but blocks exit to the water return line during backwashing, and instead opens access through the sleeve body for backwashing, using a mains water supply.

A filter of the type described above can be operated continuously and more efficiently than existing rapid sand filter-pump systems, by using a single-speed swimming pool pump optimized for both forward filtration and chlorination. This increase in daily operation time that results does not affect (i.e. shorten) the intervals at which backwashing operations are required to be performed in order to remove entrapped dirt from the filtering medium contained within the individual trays and provides benefits in energy saving and better circulation and skimming of water.

Embodiments of the invention also include a method of effecting filtration of a commercial or household swimming pool, wherein a charge of filter sand is subdivided and received in a plurality of shallow-bed sand filter trays that are preferentially stacked one on top of another and which form integral part of a filter unit tank which has a pool water inlet, a pool water outlet and a backwash water outlet, wherein water flow from a swimming pool to and from the filter unit tank and the trays is selectably switchable in a manner whereby (a) pool water is caused to flow in parallel (as compared with sequentially) under low pressure in a forward flow direction into all trays and from these via a pool water return conduit common to all trays to the pool water outlet during pool water filtering operation of the unit, and (b) backwash water supplied to the filter unit tank is caused to flow into an individual one of the trays in reverse flow direction such as to fluidize sand received in the individual tray while the others remain shut-off from such backwash water flow, and discharge the water from the tray being backwashed towards the backwash water outlet during filter backwashing operation of the unit, whereby the individual trays are backwashed individually but in sequence one after the other.

Further features and advantages of the present invention will become apparent to a skilled addressee from the following detailed description of a preferred embodiment of the invention, provided with reference to the accompanying drawings.

### DESCRIPTION OF THE DRAWINGS

FIG. 1 is a schematic diagram of a pool water filtration circuit incorporating a filter unit embodiment in accordance with the present invention;

FIG. 2 shows an isometric view, partially in section and with some details omitted, of a modular filter unit according to a preferred embodiment of the present invention, in elevation, partially in section;

FIG. 3a shows an isometric view from above of two, shallow bed filter tray modules 20 which form part of the unit of FIG. 2, stacked and secured to one another using an annular locking clamp, with a component of the valve arrangement received therein only shown partially;

FIG. 3b shows an elevation section of the two stacked filter tray modules of FIG. 3a;

FIG. 3c shows an enlarged detail view from FIG. 3b, of the rim zone where the two tray modules join;

FIG. 4 is a perspective, exploded view of the components which make up one of the filter tray modules shown in FIG. 3a;

FIG. 5a is an elevation, and cross sections taken along lines F-F, B-B and A-A, of a hollow tubular valve body (sleeve) which forms part of three rotary sleeve valves of a valve arrangement which controls flow of water to/from the stacked filter trays and within the modular filter unit of FIG. 2;

FIG. 5b is a developed schematic view of the different ports (holes, through-slots) present in the sleeve of FIG. 5a;

FIGS. 6a and 6b are respective, angularly rotated, perspective views of the hollow rotary valve body of FIG. 5, as received in a ported bush at the bottom cap (or base member) of the filter unit of FIG. 2 thereby providing a rotary sleeve valve for switching backwash water flow out of the inside of the modular filter unit via the tubular valve body towards waste;

FIG. 7 is an exploded isometric view of the assembly of header cap and hollow tubular valve body, with a ported cylindrical bush which cooperates with the ports at an upper part of the hollow rotary valve body and ports in the header cap and bush to provide a further rotary sleeve valve to switch water flow out of and into the inside to the tubular valve bod;

FIGS. 8a and 8b are different perspective (isometric) views of the header cap of the filter unit of FIG. 2; and

FIG. 9a is a perspective, exploded view showing the constituent parts of an alternative embodiment of a filter tray module that can be used in the assembly of a filter unit similar to that shown in FIG. 2, whereas FIG. 9b is an isometric view showing the bottom of the tray of FIG. 9a.

### DETAILED DESCRIPTION

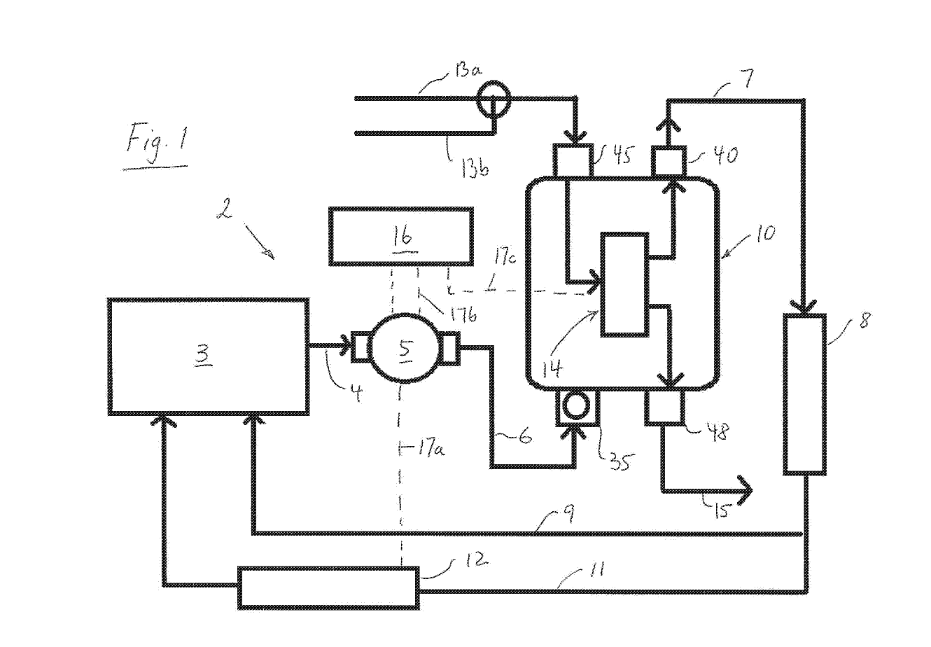

Referring first to FIG. 1, there is illustrated in schematic fashion a low pressure water filtration circuit 2 for use in filtering and sanitizing a typical backyard swimming pool 3 (20,000 to 50,000 litre capacity, for a typical example). Circuit 2 includes a suction line 4 leading in known manner from a skimmer box at the pool 3 to a low power, e.g. 200W, DC single speed pump 5 (rated e.g. for operating pressures up to 10 psi (68.9 kPa)) whose low pressure discharge port connects via pipe 6 to a pool water inlet coupling 35 of a modular, multi-bed filter unit 10. Filter unit 10 is a type of rapid sand filter in as much it uses granulate filtering medium such as sand or Zeolite or other granulate material for removing particulate impurities from water as it passes, pump-assisted, under low pressure through filter unit 10. However, as will become clear in the following, it is different from typical pressurized rapid sand filters commonly found in backyard swimming pool filtration circuits.

Filter unit 10 comprises a valve arrangement, schematically illustrated at 14, which will be described below in detail, for regulating the flow of filtered water towards a pool water return coupling 40 of unit 10 which in turn is connected to outlet pipe 7 leading to chlorinator unit 8 which in turn is connected via return pipe 9 to the water return inlet at the pool 3, for recirculation of filtered water back into swimming pool 3. FIG. 1 also illustrates the presence of a dedicated pool sweep line 11 with dedicated pool sweep pump 12 for operating a traditional in-pool cleaning device (not shown) for collecting leaves and other dirt that may find its way into the pool and which deposits on its floor.

Furthermore, as can be seen from FIG. 1, a mains water line 13a is connected to a mains water coupling 45 of unit 10 for supplying mains water, under the control of valve arrangement 14, in selective manner to unit 10 in order to effect filter medium backwashing operations as explained below. Other sources of water (shown schematically by line 13b) may be switched into water line 13a, e.g. from a rain water tank or even from the pool itself, pump or gravity assisted, to complement or replace mains water as the backwashing fluid.

Valve arrangement 14 also serves to selectively direct water used during a backwashing operation, from within filter unit 10 through its waste water discharge coupling 48 to a waste water line 15.

But for the low power DC circulation pump 5 and filter unit 20, and filtration operation parameters which these components enable, the filtration circuit 2 may be a conventional one and will not be described further. A micro-processor driven ‘smart controller’ 16 is used for control/operation of the components of the system, including pump 5, pool sweep pump 12, valve arrangement 14, chlorinator 8 and other pool equipment that may be present, either using wired control lines, some of which are illustrated at 17a, 17b and 17c leading to pool seep pump 12, low pressure pump 5 and valve 14, respectively, or through use of appropriate wireless technology, thus providing a fully or semi automated pool water filtration system.

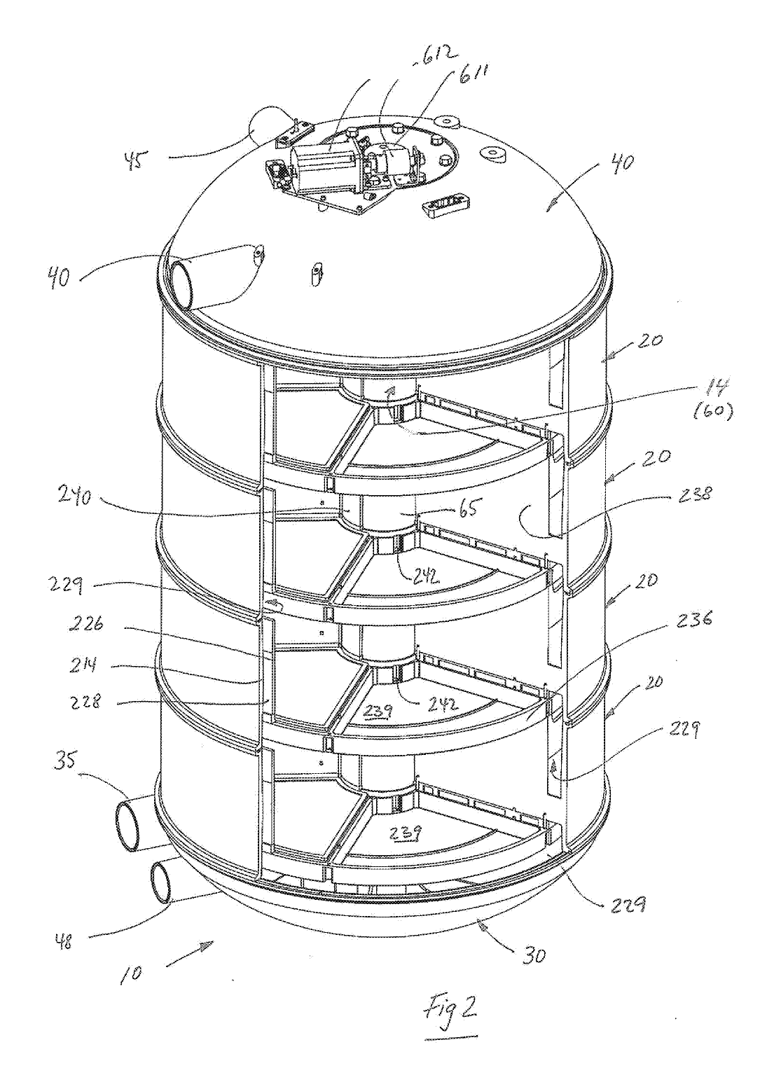

Turning next to FIG. 2, an isometric view, partially in section and with some details omitted, of a modular filter unit 10 according to a preferred embodiment of the present invention is provided. The main components of unit 10 are four squat cylindrical, shallow-bed filter trays 20 (modules), stacked about a common central axis in sealing engagement with one another, a header cap 25 and a base or bottom cap 30 which close off the open upper and lower ends of the column tank provided by the four modules 20, to define a vessel or filtration tank.

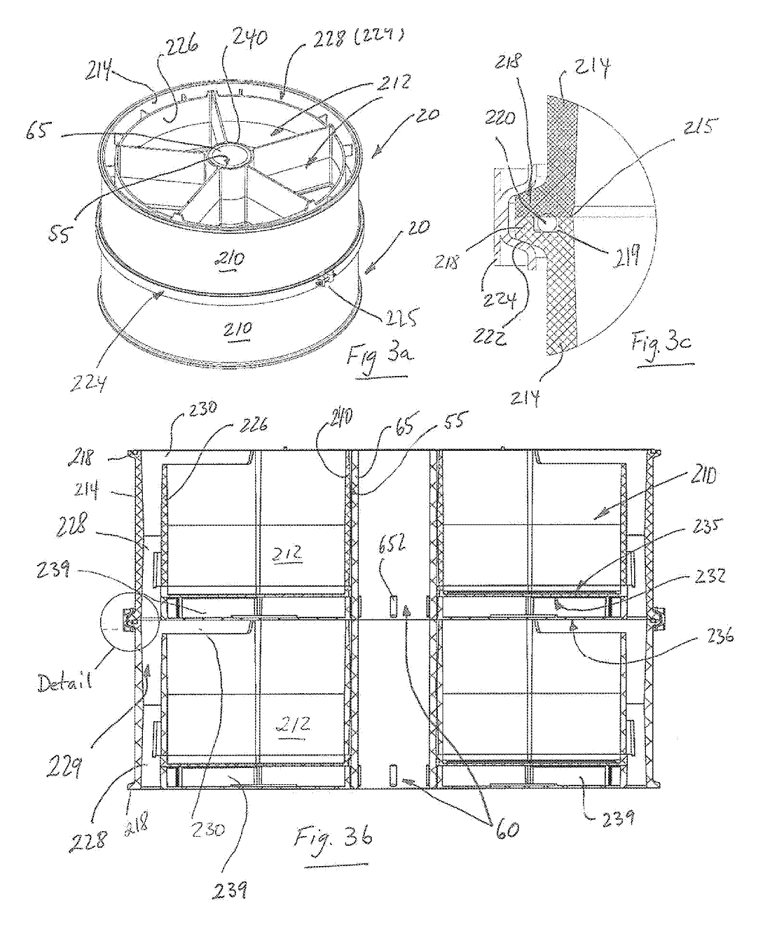

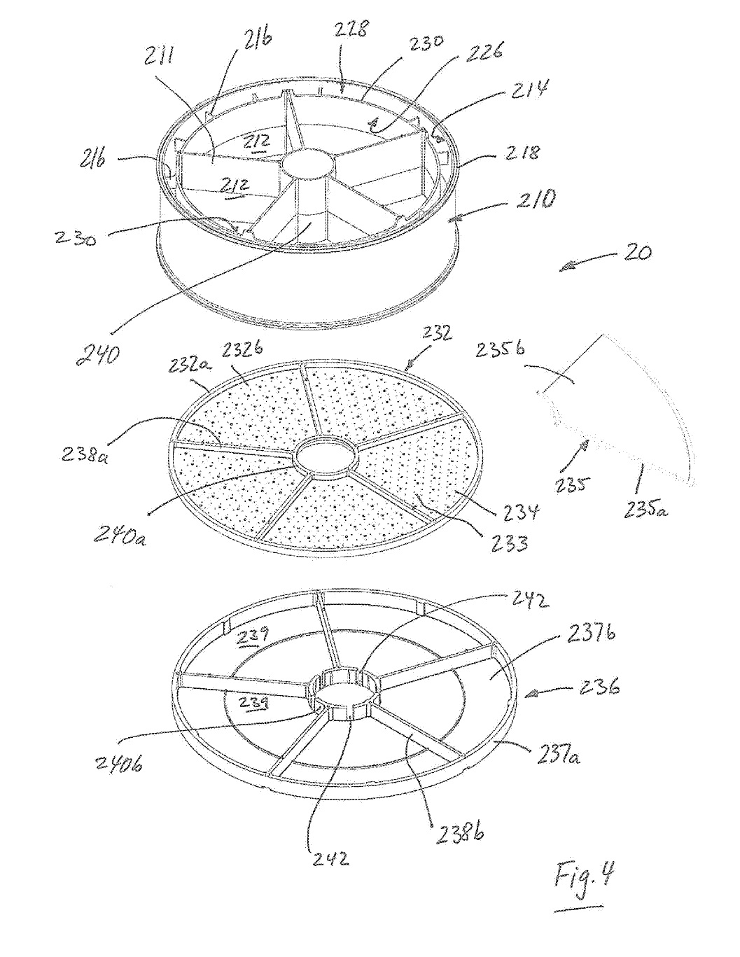

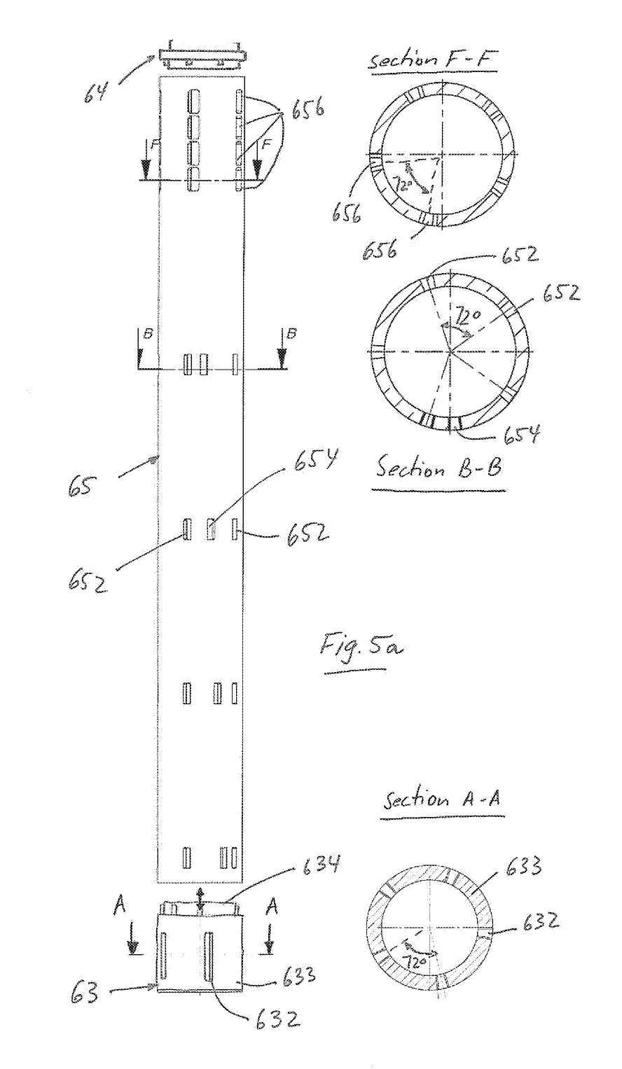

As best seen in FIG. 4, each modular tray 20 comprises an integrally manufactured (e.g. by casting) polymeric tubular-cylindrical main body part 210 having an outside, continuous cylindrical wall 214 and a radially inward intermediate cylindrical wall 226, concentrically located, which connects to outer wall 214 by way of a plurality of radial webs 216 which are equi-angularly spaced about the periphery of intermediate wall 226. The annular space 228 between outer and intermediate walls 214 and 116 define, in the stacked column of trays 20, a contiguous annular water flow channel 229 (see FIG. 3b and FIG. 2) which extends axially along the stacked trays and which opens into the inside of the semi-hemispherical (or dome shaped) bottom and header caps 30, 40, respectively.

As best seen in FIG. 3a to FIG. 3c, the terminal upper and lower edges of outer wall 214 of main body part 210 are radially flanged 218 to provide facing, shape fitting abutment surfaces 215 which facilitate stacking of trays 20 on top of one another. The abutment surfaces 215 may be provided with respective form-fit elements (not shown) to allow positive fixing of the rotational position and location of the trays 20 with respect to one another. It will be seen in FIG. 3c that a sealing gasket or O-ring 220 is received within a groove 219 in the upper rim of the flanged portion 218 of outer wall 214. This serves to ensure watertightness of the stacked trays 20; a similar sealing mechanism is also provided between the lower most and upper most of trays 20 and bottom cap 30 and header cap 25, respectively.

Furthermore, the radially flanged rim portions 218 have an exterior profile which is adapted to cooperate with a split locking ring 224 made from suitable spring steel (or other suitable material) that can be tensioned about the mating rim portions 218 of stacked trays 20 in order to secure these to one another (through wedging) against axial and radial displacement. To this end, one of the terminal portions of split locking ring 224 is provided with an integrated nut and the other end with a flange having a through hole, so that a threaded bolt can be used to force the ring ends towards one another and so tension the ring 224 about the tray rim flanges 218, in effect providing a locking mechanism 225 for the stacked trays 20.

As can be seen further in FIG. 3a and FIG. 4, a total of five spoke webs 211, uniformly spaced in peripheral direction of inner wall 226, extend radially inward and terminate at a central circular-tubular duct portion 240 of main body 210, thereby defining five discrete volume segments or cells 212.

It will be also noted that the upper rim of intermediate wall 226 is height-recessed as compared to the upper rim of exterior wall 214, see FIG. 3b, thereby to provide ingress openings 230 for water flow from annular passage 228 past intermediate wall 226 into the cells 212 defined within main body 210 when two trays 20 are stacked on top of each other. The coaxial central tubular duct sections 240 have upper and lower rims machined to be in the same plane as the upper and lower rims of outer wall 226 and provide a form fit abutment for adjoining duct sections 240, preferably sealing, whereby when the four trays 20 are stacked, a central, common return flow conduit 55 is defined within the enclosure defined by the capped-off and stacked trays 20.

Reverting to FIG. 4, each tray 20 furthermore comprises a one-piece (e.g. molded) floor member 236 which provides a water impervious bottom closure of each tray 20 but only as regards the cells 212 located radially inside intermediate wall 226 and so as to not obstruct the annular passage 228 defined between outer and intermediate cylindrical walls 214 and 226. The outer diameter of low-rise cylindrical rim wall 237a of floor member 236 is thus matched to that of intermediate wall 226. It will be further noted also that five low-rise radial webs 238b, arranged in the same pattern as webs 211 of upper main part 210, extend upwardly from floor plate 237b and between rim wall 236a and an inner most circular tube stub 240b. Stub 240b has an inner diameter matched to that of and is a contiguous extension of tubular duct section 240 of cylindrical main body 210 of tray 20.

A perforated intermediate floor member 232, which has the same outer diameter as rim wall 236a, is located on top of cylindrical rim wall 236a and abuts against the lower rim of cylindrical intermediate wall 226 such as to provide a water-flow pervious support surface for granular filer material received in the cells 212 of upper (main) part 210 of the tray 20. As is the case with main body 210 and bottom floor member 236, five radially extending ledges or bars 238a which protrude upwardly from perforated floor plate 232b, are located to complement the segmentation present in the other two parts 210, 236, whereas a central circular bar 240a ensures that water flow from cells 212 in main body 210 into the water flow duct 55 formed by the stacked arrangement of tubular duct sections 240 and tube stubs 240b can only take place, past the perforated floor plate 232b, through the five tray water flow ports 242 at bottom flow member 236.

The bottom floor member 236, perforated intermediate floor member 232 and main body 210 are glued or otherwise joined permanently together in the assembled state shown in FIG. 3b.

In essence, the perforated floor plate 232b, solid floor plate 237b, outer cylindrical low-rise wall 237a, inner stub 240b and radial webs 238b define discrete segment volumes 239 located underneath of and in registration with the cells 212 in main body 210 of tray 20. The respective tray water flow ports 242 present in each segment volume 239 allow water flow between the discrete volumes 239 and the common flow conduit 55 and define together a tray's filtered water discharge outlet.

The number, diameter and arrangement of preferentially fluted perforations 234 in perforated floor plate 232b can be determined according to water flow requirements of the filter unit 10. In order to decouple in particular the maximum permissible diameter of the perforations 234 from a diameter that would be imposed to prevent the smallest ones of the particulate filter material received in the cells 212 of the shallow-bed filter trays 20 from being flushed through the filter unit 20, it is advantageous to provide for each cell mesh inserts 235, comprised each of an outer frame 235, whose contours match the floor plan of each segment/cell 212, and a mesh material 235b whose mesh-size is chosen to prevent filter material flushing through during filtering of pool water. A plurality of small dimples 233 may be provided on the top surface of perforated floor plate 232b to prevent coplanar abutment of mesh insert 235b on the top surface of plate 232b.

FIGS. 9a and 9b illustrate a modified embodiment of a filter tray 20′. Essentially, the design and geometric configuration follows that of tray 20 shown in the other figures, but for the differences specifically noted in the following. Similar reference numerals have thus been used to denote functionally and constructionally equivalent components, whereas an apostrophe has been added to the reference numerals where changes are relevant.

The cylindrical main body part 210′ and the lower solid floor 236′ of the filter tray module 20′ are made unitary, i.e. molded in one piece, as compared to being assembled from two components that are glued together as per FIG. 4. Consequential to this modification, for reasons of manufacturing, the single upper perforated floor member 232 shown in FIG. 4 is replaced by five individual and identical perforated floor insert segments 232′, of which only one is shown in FIG. 9a for clarity purposes. These perforated floor insert segments 232′ (with dimples and through-holes as previously described) have an outer contour (in top plan view) dimensioned and complimentarily shaped such as to enable these to be secured in form-fitting manner within the cells 212 segmented by the radial webs 211 which extend between the intermediate cylindrical wall 226 and central tubular duct section 240 of cylindrical main body 210′. A lower integral edge or flange 238b′ running along the outer contour of each floor insert 232′ has a height similar to that provided by the radial webs 238b of the solid floor member 236 of FIG. 4, such that the spacing and volume defined between the perforated floor insert segments 232′ and solid floor 236′ follows that of the embodiment of FIG. 4. The embodiment of FIG. 9a will also have five mesh insert members 235 as described previously, for supporting the filter sand load received in the cells 212.

A further point of difference is provided in that a tubular insert member 241 is received in sealing and rotationally fixed manner within the central tubular duct section 240 of the main body part 210′, the insert member 241 having five rectangular holes 242′ in the tubular wall which are rotationally indexed from one another as per the indexing of the tray water flow holes 242 at the bottom of the duct section 240, but whose angular width may be different (or the same) as flow holes 242. This measure allows the use of insert members 241 having different widths of holes 242′ in order to fine tune water flow pressure at the trays themselves.

A final point of difference may be seen in that lower end of tray body part 210′ has a terminal peripheral skirt 250 whose diameter is slightly larger than the rest of body 210′, with five, peripherally equi-distantly spaced female keying indentation triplets 251 and duplets 252′ provided at the lower terminal rim of the tray body part 201′, whereas an upper peripheral skirt section 254 of main body 210′ has a diameter that allows the terminal lower peripheral skirt 250 of a tray to be received in formfitting, preferably sealing engagement over it. Five male keying finger duplets 255 and triplets 256 protrude radially from the upper peripheral skirt 254, at a lower edge, peripherally indexed such as to allow stacking of individual trays 20′, partially inserted into one another, in the correct rotational position, and glued or solvent-welded together to provide a low-pressure vessel as was described previously with reference to the embodiment of FIG. 4 (but for the difference in constructional elements present to join the trays 20 to one another in water-tight manner).

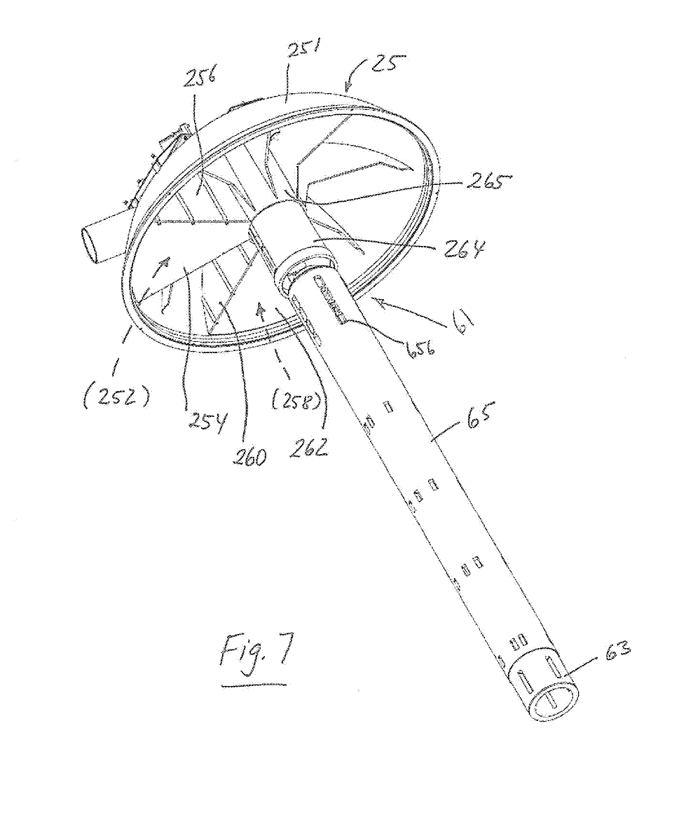

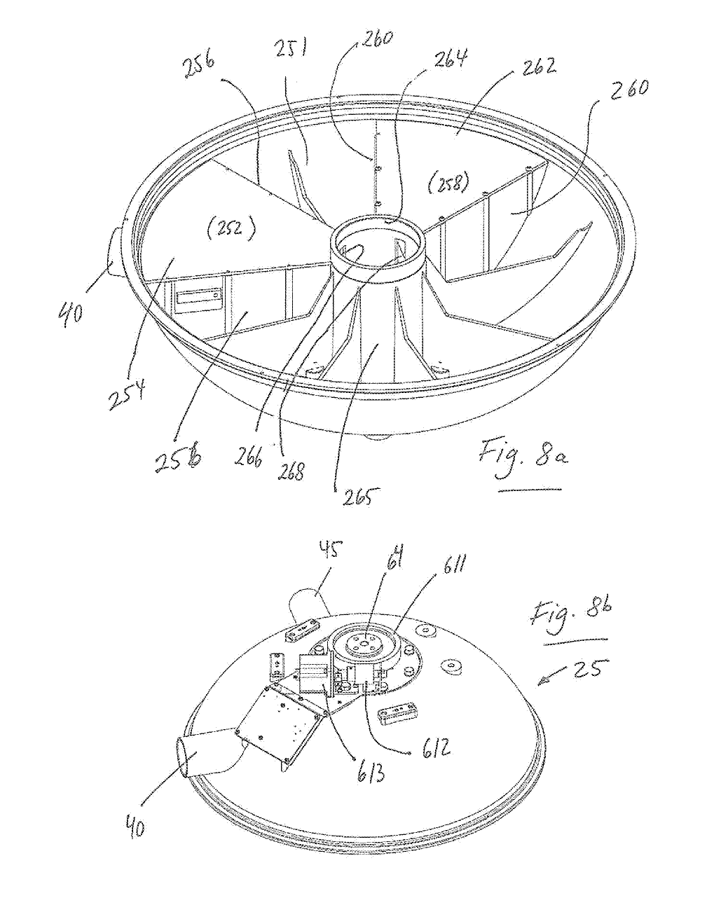

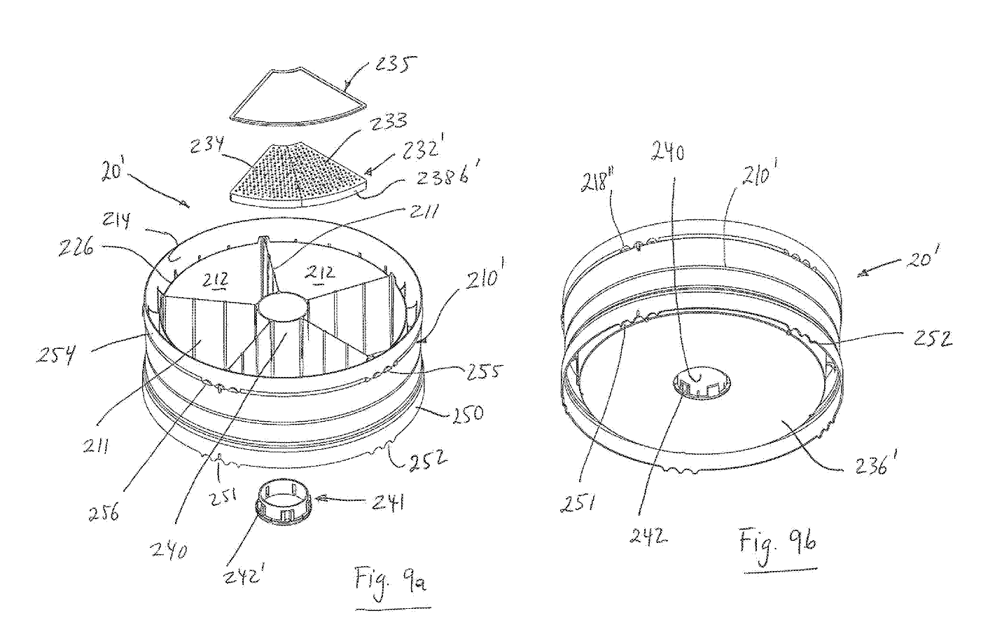

FIGS. 7, 8a and 8b illustrate the header cap 25 of filter unit 10 in further detail. Cap 25 includes the pool water return coupling 40 by way of which filter unit 10 is connected in conventional manner to the pool return line (as per FIG. 1), as well as a backwashing water connection coupling 45 for effecting filter backwashing operations using mains or another source of water, as will be describe below.

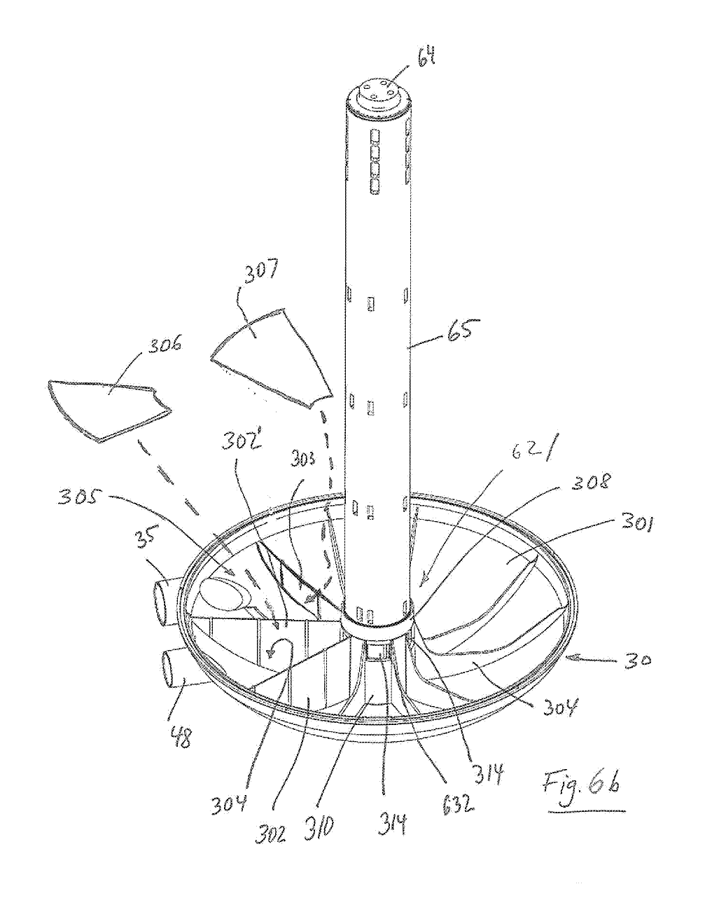

The bottom cap 30 of filter unit 10, which is illustrated in further detail in FIGS. 6a and 6b, incorporates the pool water inlet coupling 35 by way of which filter unit 10 is connected in conventional manner to the pool's water discharge line (i.e. pipe) as per FIG. 1, as well as a waste water coupling 48 for connecting to a line for discharging backwash water obtained during backwashing of the individual shallow-bed filter trays 20. Backwash water can be directed for recycling, if desired (i.e. using a pipe leading to a water recycling tank or similar, instead of sewerage). The couplings are illustrated schematically, and may be in their simplest forms tubular stubs, as the specific way in which such connectors are devised may vary, as is known to the skilled person in swimming pool rapid sand filters.

Both header and bottom caps 25 and 30 are generally semi-hemispherical or dome-shaped in overall configuration, with an outer shell wall 251, 301 stiffened by internal web members (exemplarily identified by reference numbers 256, 260 and 302, 302′, 303 and 304 in the respective FIGS. 6, 7 and 8) which radially converge towards a central tubular stump or hub 265, 310 whose function will be explained below. The bottom cap may furthermore incorporate suitably dimensioned and shaped external webs that provide footings for mounting the unit 10 to a foundation (not shown). Alternatively, a suitable cradle structure may be employed to secure the unit 10 in upright orientation to a support base. Further, the bottom cap 30 may comprise an integrally formed cylindrical skirt (not shown) which provides a stand or cylindrical foot for the entire unit.

A simple one-way flap or tongue valve (not illustrated) may be present within or at the pool water inlet coupling 35 whereby water pumped into the filter unit 10 against back pressure inside the tank defined by filter trays 20, header and bottom caps 25, 30 will maintain the valve open, whereas absence of pump pressure will suffice to hermetically close shut the pool water supply towards unit 10. Alternatively, and as will be described below, a two-way valve arrangement to also selectively shut off back flow of water from within the tank towards pool water inlet coupling 35 can be provided.

A dedicated backwash (or refuse water) chamber 304 is formed within bottom cap 30 at a location where refuse water coupling 48 is located, sealed off from the remainder of the inside of cap 30. Chamber 304 is defined between two of the radially extending webs 302 and 302′, a closure plate 306 glued or otherwise secured to and spanning the terminal free edges of the two webs 302 and 302′, an outer surface portion of central tubular hub 310 and the spherical shell wall portion located between the radial webs 302 and 302′. The closure plate 306 is shown in place over webs 302, 302′ in FIG. 6a, partially cut-off (for the sake of clarity), and removed in the partially exploded view of FIG. 6b.

As can be seen in FIG. 6a, a discharge port 312 is formed in the wall of central tubular hub 310 to enable communication from within hub 310 towards the waste (backwash) water coupling 48 via sealed-off chamber 304, but not otherwise.

It will be further noted that a dedicated pool inlet water chamber 305 is formed in a manner similar to refuse water chamber 304, but located within bottom cap 30 at a location where inlet water coupling 35 is located, sealed off from the remainder of the inside of cap 30. Chamber 305 is defined between two of the radially extending webs 302′ and 303, a closure plate 307 glued or otherwise secured to and spanning the terminal free edges of the two webs 302′ and 303, an outer surface portion of central tubular hub 310 and the spherical shell wall portion located between the radial webs 302′ and 303. The closure plate 307 is shown in place over webs 302′ and 303 in FIG. 6a, partially cut-off (for the sake of clarity), and in exploded view (removed) in FIG. 6b.

A number of additional ports 314 are provided in the cylindrical wall of hub section 310 which allow communication into the interior of hub 310 from within the bottom cap 30 as well as from within pool inlet water chamber 305. It will be noted further that a cylindrical bush 308 with ports coinciding with those present at the hub 310 is inserted and secured against rotation (e.g. tight press-fit) within hub 310.

Turning next to FIGS. 7 and 8a in particular, it can be noted that the overall configuration within header cap 25 is similar to that of bottom cap 30 in as much as a central tubular stump or hub 265 is integrally formed with shell wall 251, as are radially extending stiffening webs 256, 260 on the shell wall 251. Here again, volume zones are sealed-off between neighboring radial webs 256 and neighboring radial webs 260 by capping the neighboring webs using respective removable plate members 254 and 262 thereby to define respective ducts 252 and 258 that are sealed-off from the remainder of the inside of header cap 25. These sealed-off volumes define, respectively, a filtered pool water return chamber (or duct) 252 at the location of and in communication with the pool water return coupling 40, and a separate mains water supply chamber 258 at the location of and in communication with the mains water coupling 45.

In contrast to the arrangement within bottom cap 30, however, there are no ports provided in the cylindrical wall of hub 265 that communicate with the interior of the cap 25 other than ports 266 and 268 which respectively enable water passage between the two chambers 252 and 258 and the inside of hub 265. As is the case with the lower cap 30, a cylindrical bush 264, having ports dimensioned and indexed to coincide with those present at hub 265, is inserted in form and press-fitting manner into hub 265 so as to remain in a rotationally fixed manner.

As can be seen from FIGS. 6a and 6b, a tubular element, which forms part of the water flow control valve arrangement 14 of the filter unit 10, is journaled (i.e. supported in a manner allowing rotation) within bush 308 (and thus hub 310). As can be gleaned from FIG. 7, the tubular element is equally supported for rotation at the header cap 25 by being received in bush 264 located within hub 265.

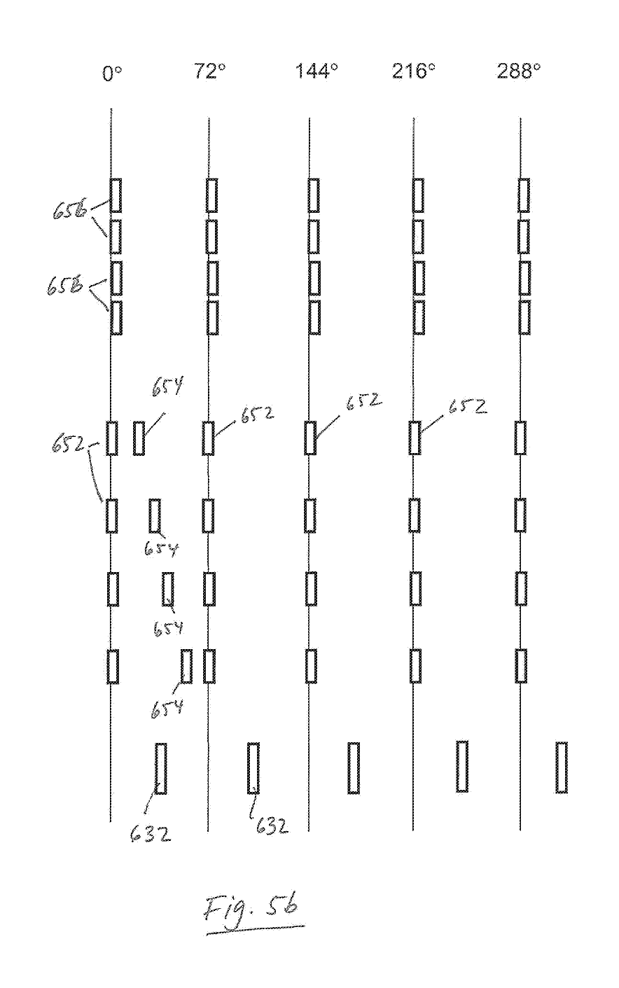

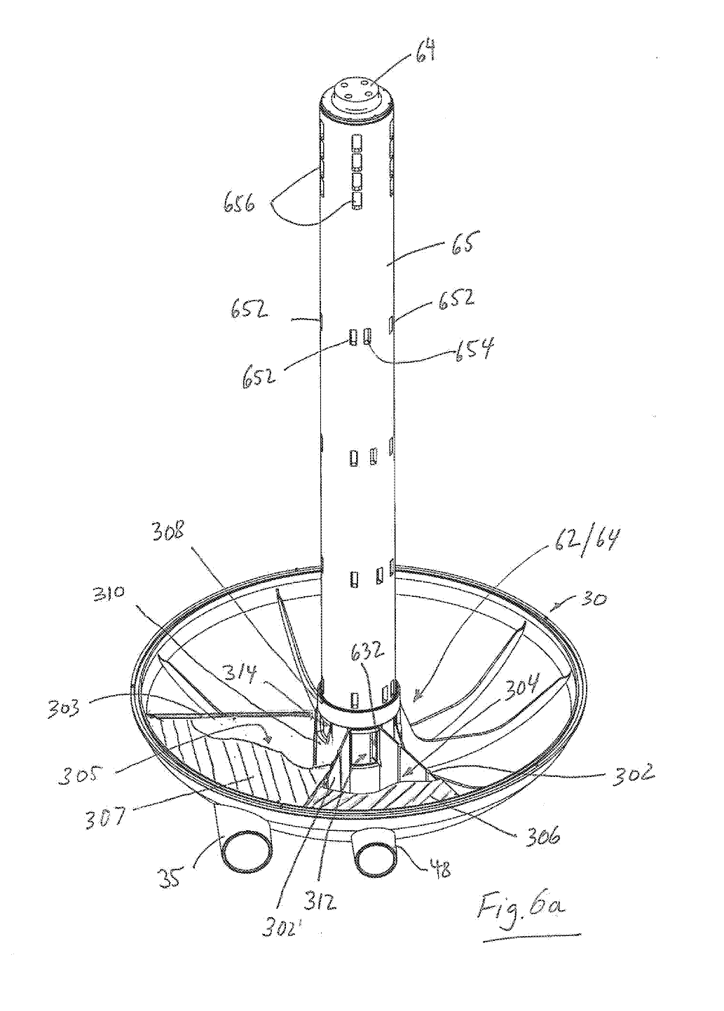

Turning next to FIG. 5a, it illustrates the hollow tubular element consisting of a sleeve body 65, essentially a PVC tube or similar rigid sleeve, with a plurality of through holes (or ports/slots) in its mantle (or wall), arranged in an indexed pattern along its axial extension as well as in circumferential direction, is illustrated, as will be described. Sleeve 65 has an outer diameter matched (e.g. machined) to be received within the common flow conduit 55 formed by the tubular duct sections 240 of the stacked modular trays 20, in a manner allowing rotation thereof but nonetheless providing as tight as necessary fit to prevent substantial water flow taking place in axial direction along the outside (exterior) of sleeve 65 when received in conduit 55. In a modified embodiment, it is conceivable to have a number of circumferential grooves in which sealing rings are received along the axial extension of sleeve body 65 to achieve such sealing mechanism, preferably one such ring per tray 20, plus one at each terminal end where the sleeve body 65 will be received within the header and bottom caps 40, 30 as is explained below.

The lower, open terminal end of tubular body 65 is closed off by cylindrical-cup shaped member 63 which has a total of five identical, equi-distantly spaced through-slots (or ports) 632 in its peripheral wall 633, a top plate 634 of cup member 63 fitting into and securing it permanently to sleeve 65 for synchronous rotation with it. Top plate 634 obstructs axial flow of water from within sleeve 65 into the inside of cup member 63. This two-piece construction could be replaced by a one-piece embodiment, noting the presence of a partition wall (as provided by top plate 634 being essential in such case.

The upper open terminal end of sleeve body 65 is capped off by an actuator cap 64 which is secured permanently against rotation and axial displacement to sleeve 65.

Sleeve body 65 provides, together with lower terminal cylindrical cup member 63 and upper terminal closure member 64, a rotatable valve body common to four distinct rotary sleeve valves 60, 61 and 62 which control water flow through the filter unit 10 as will be explained below.

For a filter unit 10 having four shallow-bed filter tray modules 20, each having five discrete filter sand cells 212, as illustrated in the embodiment of FIG. 2, sleeve body 65 will have a total of twenty (20) ‘forward flow’ through-slots or holes 652 in its peripheral wall, equally indexed in peripheral direction of sleeve 65 (i.e. spaced at 72 degree intervals) and spaced along the axial extension of the valve body (i.e. sleeve 65 plus lower cup-member 63 plus actuator cap 64) to coincide with the axial location of the tray water flow slots 242 of the stacked trays 20 of unit 10. Given that the circumferential indexing of tray water flow slots 242 in each of the stacked filter trays 20 is also 72 degrees, rotation of sleeve 65 within flow conduit 55 will simultaneously enable or shut-off communication between the interior of the sleeve 65 and all cells 212 by obstructing or opening the tray water flow slots 242 in the discrete volumes 239 below the cells 212. FIG. 5b shows a ‘development view’ of the sleeve's mantle (cylindrical wall) to illustrate the location of the slot-shaped forward flow holes 652 in the wall of sleeve 65 (as well as the flow ports 632 of cup member 63).

FIGS. 5a and 5b also show the presence of four (4) backwashing flow holes (through-slots or ports) 654 in the peripheral wall of sleeve 65, equal in number to the number of trays 20 of unit 10, a single one backwashing flow hole 654 arranged to service a respective one associated tray 20. The backwashing flow holes 654 are rotationally indexed along the axial extension of sleeve 65 (i.e. in a ‘stepped’ arrangement as shown in FIG. 5b), such that when one backwashing flow hole 654 is brought to coincide with any one of the tray water flow slots 242 of its associated filter tray 20, by rotating valve body 65 within flow conduit 55, the other three, axially separated backwash flow holes 654 do not overlap (register) with any of the tray water flow slots 242 of the respectively associated three other filter trays 20.

Equally, the indexing of backwashing flow holes 654 and forward flow holes 652 in relation to one another is such that while one backwashing flow hole 654 coincides with any one of the tray water flow slots 242 of its associated filter tray 20, all of the forward flow holes 652 are closed off, i.e. rotationally off set from the tray water flow slots 242 of the respectively associated filter trays 20.

This arrangement of tray water flow slots 242, forward flow holes 652 and backwashing flow holes 654 at the individual trays 20 and the sleeve 65 received within common return flow conduit 55, respectively, provide the first rotary sleeve valve 60 which controls flow of water from and into individual trays 20 via the inside of sleeve 65.

It will then be appreciated that selective rotation of sleeve 65 by 72 degrees causes the backwashing flow holes 654 to align with the tray water flow holes 242 at each sector 212/239 in a predetermined sequence, enabling backwashing of filter sand contained in each segment/cell 212 individually, rather than simultaneously. Such can be effected using comparatively low mains water pressure, as compared with the typical high pressure relied upon in conventional, fully fluidizing rapid sand filters, as is explained below.

On the other hand, selective rotation of sleeve 65 by 72 degrees to cause registration of one forward flow hole 652 with any of the tray water flow holes 242 in the filter tray 20 which is at the same axial level as the forward flow hole 652 will cause all forward flow holes 652 to register with the tray water flow holes 242 at each level, i.e. all 20 flow holes 652 will register with the 20 tray water flow ports 242 of all filter trays 20, which in turn enables all trays 20 to discharge filtered pool water simultaneously into the inside of sleeve 65.

A second rotary sleeve valve 61 for selectively permitting and shutting-off water flow between the inside of sleeve 65 and the pool water return coupling 40 at the header cap 25 of filter unit 10 requires then the presence a plurality of water supply holes (through-slots or ports) 656 formed near an upper end in the wall of sleeve 65. Five axial rows (or columns) comprising four discrete slots 656 each are provided per filter tray 20, rather than five, larger single slots, to maintain structural rigidity of the upper end of sleeve 65, given that it may be subject to substantial torque in effecting rotation of the tubular valve body in operating the rotary valves 60, 61 and 62. The number of slot 656 rows must be equal to the number of cells 212 of the filter trays 20 in filter unit 10, and must be equally indexed in peripheral direction of sleeve 65, in this case 72 degrees, but should be rotationally off-set to the forward flow holes 652 of first rotary sleeve valve 60. Water flow between the interior of the sleeve 65 and the pool water return duct (chamber) 254 provided at header cap 25 (and thus pool water return coupling 40 can thus be effected by rotating sleeve 65 as required into the relevant rotational position.

On the other hand, the angular spacing of ports 266 and 268 leading from the interior of bush 264 (and thus the interior of sleeve 65 via its water supply through slots 656) towards the pool water return chamber 252 and the mains water supply chamber 262, respectively can be chosen to enable filling of the pool (via pool water return coupling 40) without effecting water passage through the filter trays 20).

In order to effect backwashing, sleeve 65 can be rotated such that one column of through slots 656 is brought to align with slot 268 at the header which communicates with the mains (i.e. backwash) water supply duct (or chamber) 258 provided at header cap 25.

This enables the supply of backwash water (under mains water pressure) in a flow reversed to ‘forward flow’ direction into the interior of sleeve 65, while port 266 leading into pool water return chamber 252 is sealed off by the solid cylindrical wall portion between adjacent columns of through slots 656. Water flowing into the interior of sleeve 65 will then only be able to be discharged through a single one of the backwashing flow holes 654 into the filter trays 20, namely the one which in that rotational position also registers with one of the tray water flow holes 242, while the others remain blocked-off Consequently, selective and sequenced rotation of the sleeve 65 will cause only one cell 212 to be supplied with back washing water, via the aligned tray water flow hole 242 and backwash hole 654 into the discrete volume 239 located beneath the perforated floor 232 at the specific cell 212.

It will be noted further that the first and second rotary sleeve valves 60 and 61 share the same rotatable hollow tubular valve body (sleeve 65) which greatly reduces constructional complexity and piece count.

The third rotary sleeve valve 62 is provided at the bottom cap 30, for selectively permitting and shutting-off water flow between the inside of the filter unit 10, more precisely the continuous annular flow channel 229 defined by the stacked annular voids between outer and intermediate cylindrical walls 214 and 226 (see FIG. 3b) of the stacked filter trays 20, and the refuse water chamber 304 that is sealed off from the remainder of the interior volume of the filter unit 10.

The third rotary sleeve valve 62 comprises the cylindrical cup member 63 at the lower end of sleeve 65, with its discharge through-slots or holes 632 formed in peripheral wall 633, five in number equal to the number of cells 212 of the filter trays 20, and the cylindrical hub 310 (with its bush element 308) which has single egress port 312 leading into discharge chamber 304 and the ingress ports 314 through which water may flow from within the interior of bottom cap 30 into cup member 63 during registration of its through slots 632 with ingress ports 314, noting that registration will also take place simultaneously between the egress port 312 and one of the other discharge slots 632 of cup member 63.

Noting that water flow is reversed during backwashing operations, water flowing into the interior of sleeve 65 will pass from there into the single cell 212 whose tray water flow slot 242 is aligned with the relevant backwash flow hole 654, in the process gently removing water solids trapped in the filter bed present in that cell 212 and taking same past the recessed upper rim of intermediate cylindrical wall 226 into the annular void 228 and flow channel 229 towards the bottom cap 30. Water can flow past the ingress ports 314 into the interior of cup member 63 and from there via the equally aligned discharge slot 632 and egress port 312 into the sealed-off discharge chamber 304 and from there into the waste line coupled at coupling 48.

The fourth rotary sleeve valve 64 is present also at the bottom cap 30. It is devised primarily to selectively prevent back flow of water from within the filter unit 10, more precisely the continuous annular flow channel 229 defined by the stacked annular voids between outer and intermediate cylindrical walls 214 and 226 (see FIG. 3b) of the stacked filter trays 20, towards the pool water inlet coupling 35 via the sealed-off pool water inlet chamber 305 that is separated from the remainder of the interior volume of the filter unit 10, while otherwise allowing pool water to enter into the annular flow channel 229 (and from there into the filter tray segments) via the inlet chamber 305 past the port/valve provided by the rotatable cup member 63 when the latter is in a rotational position wherein ports 314 in hub section 310 register with some of the ports 632, whereby cup member 63 essentially acts like a through flow channel, while egress port 312 leading into the waste water chamber 304 remains closed by a solid wall portion of cup member 36. It will be appreciated further that the fourth sleeve valve 64 is (must be) rotationally synchronized with the second sleeve valve 61 which regulates flow of filtered water through valve body 65 past water supply ports 656 into the pool water return chamber (or duct) 252, in that in forward filtration flow mode, water entering the tank through pool water inlet chamber 305 and past the fourth valve 64 will leave the tank via the pool water return chamber 252 after having been filtered.

Finally, as best seen in FIGS. 2 and 8b, the filter unit 20 will be provided with a step motor 613 which via worm gear 612 and disk gear 612, which is coupled to actuator cap member 64 to enable synchronous rotation therewith, can be used to effect selective rotation of the valve sleeve body to switch the three rotary sleeve valves 60, 61 and 62 which provide the valve arrangement of the filter unit 20, to direct water flow through the filter trays 20 and between the pool water return coupling 40, mains water supply coupling 45 and waste (backwash) water discharge coupling 49 as set out herein above.

Generally speaking, the filter unit 20 operates, in a nutshell, using an incoming flow of unfiltered pool water into the base cap 30, through the appropriately switched inlet water chamber 305, from where it flows in a light swirling motion upwardly within the annular flow channel 229 defined between the concentric walls 214 and 216 at the periphery of the filter tray cells 212 which contain the filter medium. The unfiltered water enters into each cell 212 of each filter tray 20 in parallel through the top of the trays (i.e. through the openings or recessed upper rim zones 230 at the intermediate cylindrical wall 226), passing though the filter media contained in each cell 212, and exiting past the perforated floor 232 of each tray 20 towards the central return conduit 55 formed by the stacked trays 20. The hollow valve member (or sleeve 65) is received in substantially sealing engagement within the return conduit 55 to selectively prevent or enable passage of water into the interior of valve member 65 of valve arrangement 14, which collects and returns the filtered water from the filter trays 20 to the header cap 25 and from there into the pool water return line. The stepper motor at the lid or header cap 25, with suitable gearing, controls stepwise rotation of the valve sleeve (and thus the three rotary valve assemblies present at the filter unit 20) to actuate suitable patterns of water flow for forward filtration, and intermittent backwash of the filter media received within the discrete cells of each tray 20.

The skilled reader will appreciate that the filter unit 20 may have a greater number of trays 20 than four, and may equally have trays 20 having an increased (or reduced) number of segmented cells 212 in which the total charge of filtration sand (or other granulate medium) of the filter unit 20 is received in discretely subdivided amounts. Equally it will be appreciated that the height of each cell 212 and the amount and level of filter medium received in each cell can be determined as required, relevant being that gentle backwash flow of mains water can be used to effect backwashing of each individual cell sequentially. In effecting backwashing, the bed of filter media held in each cell 212 of each tray 20 will be at least partially fluidized, by forcing some or all of the grains of filter media into suspension. This operation lifts and separates the media, and thereby allows trapped dirt to be washed out in the reverse of the normal filtering direction.

It will be further appreciated that the constructional elements present at the individual filter trays for securing these to one another in stacked columnar arrangement can be varied, e.g. a circular tongue and groove coupling may be present at the facing rim faces of the trays, and the unitary tensioning ring may be replaced by individual, axially acting clamps.

1. A pool water filtration unit, having a filter tank dimensioned to receive a charge of filter sand for effecting filtration of pool water in continuous, pump assisted flow through the tank, comprising multiple, shallow-bed sand filter modules located within or defining a an integral part of the tank, wherein the modules are arranged to receive in parallel (as compared to sequentially), in filtration flow mode, water from the pool at low delivery pressure and to discharge filtered water at low pressure from the modules through a pool water return conduit located within the tank and common to all modules.

2. A pool water filtration unit according to claim 1, wherein the shallow-bed filter modules comprise filter trays stacked into a column, wherein the filter tank includes bottom and header caps which cooperate with the stacked filter trays to define the low pressure vessel or tank, and wherein a pool water inlet coupling and a pool water return coupling to which pool water supply and return lines can be connected, respectively, are provided at one or both of the bottom and header caps.

3. A pool water filtration unit according to claim 2, further comprising an arrangement of valves associated with the filter modules or trays for performing the following functions: (i) selective but simultaneous switching on and off of all filtered water flow from the trays, which takes place through the return conduit common to all trays, to a or the pool water return coupling of the tank; and (ii) enabling backwash water flow into the individual filter trays in selectable order, preferably through the common return conduit, and opening a conduit for backwashed water to pass to waste in a switching state where water flow to the pool water return coupling is blocked.

4. A pool water filtration unit according to claim 3, wherein the shallow bed filter trays are segmented to define discrete cells in which respective loads of granulate filter material are received, and wherein the arrangement of valves is switchable to enable selective backwashing of the filter material loads in each cell of each tray, preferentially in sequence at each tray.

5. A pool water filtration unit according to claim 3, wherein the arrangement of valves is further devised to selectively receive water from a mains and/or other water supply through a dedicated coupling at the filter tank, and to selectively direct mains water flow to the individual filter trays or the cells within the trays, where applicable, in order to effect backwashing of the filter material received in the selected trays, or cells thereof, the arrangement of valves further configured to block pool water supply into the stacked filter trays during backwashing.

6. A pool water filtration unit according to claim 3, wherein the filter trays are squat cylindrical in configuration, having an intermediate, cylindrical separation wall radially spaced from and concentrically within an external cylindrical wall that forms part of the filter tank, the separation and external walls defining an annular void which provide, when the trays are stacked in sealing engagement, a continuous annular flow channel which is in communication with the pool water inlet coupling of the filter tank and from where pool water may flow radially past the separation wall into the filter tray segments or cells, as the case may be, which hold the filter material and which are located radially inwards the separation wall.

7. A pool water filtration unit according to claim 6, wherein the filter trays are of double floor construction, with tin upper perforated floor located spaced from an upper terminal edge of the separation wall and extending radially inward therefrom, and a lower solid floor spaced below and from the perforated floor, extending also radially inward the separation wall, wherein the perforations in the intermediate floor are dimensioned to permit passage of water with controlled flow and distribution between the segmented upper part of the tray which holds the filter material load and the equally segmented volume defined between the upper and lower floors.

8. A pool water filtration unit according to claim 7, wherein each filter tray further comprises a central tubular duct section radially inwards and concentric with the separation wall, the duct sections of stacked trays providing the common return conduit within the filter tank for filtered water towards the pool water return coupling.

9. A pool water filtration unit according to claim 8, wherein each duct section has a number of tray water flow holes located in the space between the perforated and bottom floors only, thereby providing the filtered water discharge outlet from the trays.

10. A pool water filtration unit according to claim 1, further comprising one or more of (i) means for fixing the rotational position of stacked trays on top of one another in the columnar arrangement, (ii) joining means for securing the stacked trays to one another in permanent or releasable manner, and (iii) sealing means devised to maintain watertightness of the stacked trays and bottom and header caps under operational pressure levels typically up to 10 psi plus an appropriate safety factor.

11. A pool water filtration unit according to claim 7, wherein the arrangement of valves comprises a first rotary sleeve valve, with to hollow tubular valve body received form-fittingly for rotation within the common return conduit of the stacked trays, wherein the valve body has a plurality of forward flow holes in its peripheral wall, equally indexed in peripheral direction of the valve body and spaced along the axial extension of the valve body in such manner as to permit and shut-off water flow between the interior of the valve body and all cells in each of the stacked trays, in parallel flow through the tray water flow holes, upon registration of the tray water flow holes with the forward flow holes.

12. A pool water filtration unit according to claim 11, wherein the first rotary sleeve valve has a number of backwashing flow holes in the peripheral wall of the rotatable valve body, equal in number to the number of trays of the unit, a single one said backwashing flow holes arranged to service a respective one associated filter tray, the backwashing flow holes being rotationally indexed along the axial extension of the valve body such that while water flow through the forward flow holes is maintained shut-off, selective rotation of the sleeve causes said backwashing flow holes to register with the tray water flow holes in a predetermined sequence.

13. A pool water filtration unit according to claim 11, wherein the arrangement of valves further comprise a second rotary sleeve valve for selectively enabling and shutting-off water flow between the inside of the tubular valve body of the first rotary sleeve valve and the pool water return coupling of the filtration unit.

14. A pool water filtration unit according to claim 13, wherein the first and second rotary sleeve valves share the same rotatable hollow tubular valve body.

15. A pool water filtration unit according to claim 3, wherein the arrangement of valves further comprise a third rotary sleeve valve for selectively enabling and shutting-off water flow between the inside of the filter tank and a refuse water duct which is sealed off from the remainder of the interior volume of the filter tank and which leads to a water discharge coupling of the filter tank.

16. A pool water filtration unit according to claim 15, wherein the third rotary sleeve valve comprises a cylindrical cup or ring element having a number of discharge holes formed in the peripheral wall thereof, in number equal to the number of cells of the filter trays and indexed with the same angular spacing as that of the tray water flow holes, the cylindrical cup or ring being made integral with or secured to the lower open end of the rotatable valve member of the first rotary sleeve valve for rotation therewith, a water flow preventing partition wall being located between the cup or ring element and rotatable valve member.

17. A sand filtration tank having a water inlet through which unfiltered water can be supplied into the filtration tank and a water outlet through which filtered water can be delivered from the filtration tank, comprising: a plurality of shallow-bed filter trays arranged as modules between top and a bottom end caps of the filtration tank, the filler trays having ports for passage of water therethrough; and a valve assembly cooperating with the ports of the filter trays for regulating water flow through the filter trays by selective closing and pelting of the ports of the filter trays; wherein the filter trays each have a charge of particulate filter media; and wherein the valve assembly is arranged for operating in a forward filtration mode in which water supplied via the water inlet passes in parallel to nil the filter trays to pass through the filter media under low pressure and is returned to the water outlet via the valve assembly.

18. A filtration unit according to claim 17, wherein the valve arrangement is positioned in a central duct defined by tubular central sections of the filter trays.

19. A filtration unit according to claim 18, wherein the valve assembly comprises a cylindrical tubular body having formed therein a pattern of ports arranged to co-operate with a complementary pattern of ports formed in the central duct of the stacked filter trays, the pattern of ports defining (i) forward filtration ports for collecting filtered water discharged from the filter trays, and (ii) backward flow ports for delivering water to the filter trays in a flow direction opposite to forward filtration mode.

20. A filtration tank according to claim 17, wherein the filter trays comprise radially segmented cells within concentrically located but radially separated cylindrical walls of the trays, each cell holding a discrete charge of filter media, and wherein the radial cells of the filter trays each have a respective port formed in a central wall thereof for communication with the valve assembly, and wherein the filter trays are of double floored construction comprising a perforated filter media barrier floor and a solid lower terminal floor spaced apart from the barrier floor thereby to define a cavity between the floors.

21. A method of effecting filtration of a commercial or household swimming pool, wherein a charge of filter sand is subdivided and received in a plurality of shallow-bed sand filter trays that are preferentially stacked one on top of another and which form integral part of a filtration unit tank which has a pool water inlet, a pool water outlet and a backwash water outlet, wherein water flow from a swimming pool to and from the filtration unit tank and the trays is switchable using a set of valves in a manner whereby (a) pool water is caused to flow in parallel (as compared with sequentially) under low pressure in a forward flow direction into all trays and from these via a pool water return conduit common to all trays to the pool water outlet doting pool water filtering operation of the unit, and (b) backwash water supplied to the filtration unit tank is caused to flow into au individual one of the trays in reverse flow direction such as to fluidise sand received in the individual tray, while the others remain shut-off from such backwash water flow, and discharge the water from the tray being backwashed towards the backwash water outlet during filter backwashing operation of the unit whereby the individual trays are backwashed individually and sequentially.
